(19) United States
(12) Patent Application Publication
(10) Pub. No.: US 2012/0279402 A1
(43) Pub. Date: Nov. 8, 2012

(54) Deep Draw Active Stretch Presses for Forming Composite Articles

(76) Inventor: Jamin Micarelli, Kirkland, WA (US)

(21) Appl. No.: 13/412,363

(22) Filed: Mar. 5, 2012

Related U.S. Application Data
(60) Provisional application No. 61/449,417, filed on Mar. 4, 2011.
(60) Provisional application No. 61/449,431, filed on Mar. 4, 2011.
(60) Provisional application No. 61/449,443, filed on Mar. 4, 2011.

(51) Int. Cl. B30B 15/00

(52) U.S. Cl. 100/219

(57) ABSTRACT

High pressure composite materials presses are disclosed. Methods and machinery to preform deep draw composite materials with active stretching are also disclosed.

This application claims priority to the following three US Provisional Applications, all filed Mar. 4, 2011: 61/449,417, 61/449,431 and 61/449,443.

### TECHNICAL FIELD

The invention relates to high pressure composite materials presses; more particularly, it relates to methods and apparatus for preform deep draw active stretching of composite materials.

### BACKGROUND OF THE INVENTION

### Deep Draw Active Stretch Forming of Composite Parts

Conventional deep draw methods for ballistic material rely on using multiple pieces of material specially shaped so that the final drawn product will have a uniform thickness. These methods are believed to create weaknesses in the final drawn end product because using various shapes for the material to be drawn is believed to be inherently weaker than using full sheets. Other methods of deep drawing composite material are believed also to stretch or harm the material such that it loses at least some of its ballistic properties.

In one known process, a set of matched metal dies are closed under high pressure and heat to consolidate the composite material especially unidirectional polyethylene spun fibers in a variety of thermoplastic resin systems into a ballistic helmet or part. This is a single stage process where the material is drawn like sheet metal into a set of molds under pressure.

In another kind of conventional deep draw press a work piece is positioned between a conventional movable deep draw forming die and an expandable bladder generally filled with fluid under pressure. This is sometimes referred to as a hydrostatic deep draw. The forming die is operated by a conventional ram cylinder and the bladder is some kind of a isostatic pressure vessel, all in a lidded, lockable pressure vessel.

In general, the vessel locks closed trapping a work piece, typically sheet metal, then high pressure is applied to the bladder from one side pinning the material to a flat platen on the other side. Once the material is under pressure the hydraulic ram with a mold piece mounted on it is forced up through the bottom of the platen. Under full pressure the ram displaces liquid in the pressure chamber and in the process draws the flat material into a deep and complex shape. Deep draw in this kind of application generally refers to any draw where the depth of the draw is greater than half the diameter of the finished piece (also sometimes where the depth is greater than the diameter of the piece). Then the pressure in the bladder or isostatic vessel is lowered, the ram is retracted and the vessel is unlocked and opened to remove a finished formed part.

Examples of this kind of press may be found in Pryer Technology Group's Triform Hydroform Presses (http://www.pryertechgroup.com/about hydroform.html).

Conventional high strength, low weight structural ballistic composites are made from materials such as fiberglass or graphite. The composite article is typically made of multiple layers of such material, sometimes combining one or more types of material. Conventionally such stacks of composite fabric are laid up over a mold or die and thereafter cured under selected temperature and pressure conditions.

There are a number of conventional press systems in use for making such composite articles. An autoclave is one kind of Hot Isostatic Press (HIP) which in general applies both heat and pressure to the workpiece placed inside of it. Typically, there are two classes of autoclave. Those pressurized with steam can process workpieces that are able to withstand exposure to water, while the other class circulates heated gas to provide greater flexibility and control of the heating atmosphere, and for pieces that cannot withstand exposure to water.

Processing by autoclave is far more costly than oven heating and is therefore generally used only when isostatic pressure must be applied to a workpiece of comparatively complex shape. For smaller flat parts, conventional heated presses offer much shorter cycle times. In other applications, the pressure is not required by the process but is integral with the use of steam, since steam temperature is directly related to steam pressure. Rubber vulcanizing exemplifies this category of autoclaving.

For exceptional requirements, such as the curing of ablative composite rocket engine nozzles and missile nosecones, a hydroclave can be used, but this entails extremely high equipment costs and elevated risks in operation. The hydroclave is pressurized with water (rather than steam); the pressure keeps the water in liquid phase despite the high temperature. Since the boiling point of water rises with pressure, the hydroclave can attain high temperatures without generating steam.

While simple in principle, this brings complications. Substantial pumping capacity is needed, since even the slight compressibility of water means that the pressurization stores non-trivial energy. Seals that work reliably against air or another gas fail to work well with extremely hot water. Leaks behave differently in hydroclaves, as the leaking water flashes into steam, and this continues for as long as water remains in the vessel. For these and other reasons, very few manufacturers will consider making hydroclaves, and the prices of such machines reflect this.

U.S. Pat. Nos. 7,862,323 and 7,910,039 (both incorporated herein by reference) disclose a new kind of HIP press or pressure chamber where both heat and isostatic pressure can be applied to layered composites over comparatively complex shapes. We call such a press or pressure chamber a Boroclave (and sometimes also a bariclave). The Boroclave does not use water as a pressuring or pressure transfer medium. A Boroclave can be either oil or silicon filled, or a combination of both, with suitable separation materials. This Boroclave press is filled with a substantially incompressible medium such as silicone, where the medium at least partially encloses an elastomeric vessel filled with fluid such as oil or water and in fluid communication with a source of pressurized fluid, such that, as the vessel is pressurized inside the transfer medium, the pressure expands throughout the medium to provide a substantially uniform pressure to the work piece against the mold. The Boroclave advantageously employs a barrier or bladder to separate the pressure transfer medium itself from the layers of the composite article which is being fabricated.

High density polyethylene (HDPE) ballistic cloth fiber and other UHMW thermoplastic fibers, such as polypropylene or the like, are generally pre-stretched in the threading and weaving process by which they are formed into cloth to only around 30% of their potential length. When such fibers are created and before they are woven, the molecules of the fiber are twisted and randomly arrayed. This works for soda bottles and cutting boards, but the material is far from ballistic at that point. When this material is threaded, pulled tight and spun to produce basic ballistic cloth, the molecules are stretched into alignment, at least partially, and this gives the fiber considerably more strength. But it is still only about 30% of what is believed to be attainable by methods disclosed below.

When such conventional woven ballistic cloth fibers (which may also include Spectra and Dyneema brand UHMW fibers or the like) are heated without any pressure stabilization, they revert to random twisted form and strength is lost.

Preform Vacuum Forming of Composite Parts with Deep Draw Active Stretch

In one kind of conventional deep draw press a work piece is positioned between a conventional movable deep draw forming die and an expandable bladder generally filled with fluid under pressure. This is sometimes referred to as a hydrostatic deep draw. The forming die is operated by a conventional ram cylinder and the bladder is some kind of a isostatic pressure vessel, all in a lidded, lockable pressure vessel.

In general, the vessel locks closed trapping a work piece, typically sheet metal, then high pressure is applied to the bladder from one side pinning the material to a flat platen on the other side. Once the material is under pressure the hydraulic ram with a mold piece mounted on it is forced up through the bottom of the platen. Under full pressure the ram displaces liquid in the pressure chamber and in the process draws the flat material into a deep and complex shape. Deep draw in this kind of application generally refers to any draw where the depth of the draw is greater than half the diameter of the finished piece (also sometimes where the depth is greater than the diameter of the piece). Then the pressure in the bladder or isostatic vessel is lowered, the ram is retracted and the vessel is unlocked and opened to remove a finished formed part.

Again examples of this kind of press may be found in Pryer Technology Group's Triform Hydroform Presses. Such presses however are believed to be entirely closed when locked, and allow no part of the workpiece to be outside of the press when the press is closed. Such presses also do not use any kind of active vacuum process for their workpieces.

Conventional high strength, low weight structural ballistic composites are made from materials such as fiberglass or graphite. The composite article is typically made of multiple layers of such material, sometimes combining one or more types of material. Conventionally such stacks of composite fabric are laid up over a mold or die and thereafter cured under selected temperature and pressure conditions.

High density polyethylene (HDPE) ballistic cloth fiber and other UHMW thermoplastic fibers, such as polypropylene or the like, are generally pre-stretched in the threading and weaving process by which they are formed into cloth to only around 30% of their potential length. When such fibers are created and before they are woven, the molecules of the fiber are twisted and randomly arrayed. This works for soda bottles and cutting boards, but the material is far from ballistic at that point. When this material is threaded, pulled tight and spun to produce basic ballistic cloth, the molecules are stretched into alignment, at least partially, and this gives the fiber considerably more strength. But it is still only about 30% of what is believed to be attainable by methods disclosed below.

When such conventional woven ballistic cloth fibers (which may also include Spectra and Dyneema brand UHMW fibers or the like) are heated without any pressure stabilization, they revert to random twisted form and strength is lost.

### Dual Form Deep Draw Press Bladder

In one kind of conventional deep draw press a work piece is positioned between a conventional movable deep draw forming die and an expandable bladder generally filled with fluid under pressure. This is sometimes referred to as a hydrostatic deep draw. The forming die is operated by a conventional ram cylinder and the bladder is some kind of a isostatic pressure vessel, all in a lidded, lockable pressure vessel.

In general, the vessel locks closed trapping a work piece, typically sheet metal, then high pressure is applied to the bladder from one side pinning the material to a flat platen on the other side. Once the material is under pressure the hydraulic ram with a mold piece mounted on it is forced up through the bottom of the platen. Under full pressure the ram displaces liquid in the pressure chamber and in the process draws the flat material into a deep and complex shape. Deep draw in this kind of application generally refers to any draw where the depth of the draw is greater than half the diameter of the finished piece (also sometimes where the depth is greater than the diameter of the piece). Then the pressure in the bladder or isostatic vessel is lowered, the ram is retracted and the vessel is unlocked and opened to remove a finished formed part.

As with the background above, examples of this kind of press may be found in Pryer Technology Group's Triform Hydroform Presses.

Conventional high strength, low weight structural ballistic composites are made from materials such as fiberglass or graphite. The composite article is typically made of multiple layers of such material, sometimes combining one or more types of material. Conventionally such stacks of composite fabric are laid up over a mold or die and thereafter cured under selected temperature and pressure conditions.

### Containment of a Pressure Vessel

Many disclosures have been directed towards improved pressure vessel construction. Some deal with closure members for selectively sealing vessels capable of withstanding elevated pressures. In the field of isostatic presses and processes for using them, and especially in the area of hot isostatic presses (HIP), many improvements have also been suggested.

Pressure vessels used in HIP (and also in autoclaves or hydroclaves) require ready access to their interiors for placing and removing work pieces and tools. Thus, any closure device that seals such vessels must be relatively easy to open and close, and must be able to withstand the internal pressure of the vessel with no leakage of liquid or gas.

It is well-known that many HIP processes have serious problems in being too low in productivity, and many attempts have been made to shorten the cycle time period and to improve the efficiency of operation and use of HIP systems in general. See Japanese Laid-Open Patent Specification No. 51.124610 disclosing an improved HIP method and system.

Prior methods of meeting the two requirements of ready access and withstanding extremely high operating pressures internal to the vessel have proved both time-consuming and expensive, and sometimes not entirely effective. In one very old example, just to get into and out of a high pressure vessel, 70 long and thick bolts have to be removed and later replaced (and properly torqued of course, and usually more than once as pressure increases), and various pieces of “holding” ring and “shear” ring have to be removed and later replaced, parts of which require and overhead crane.

U.S. Pat. No. 3,992,912 to Jonsson issued on Nov. 23, 1976 discloses an isostatic press in which work pieces are enclosed in a pressure vessel filled with a liquid and closed by a lid (and discusses alternate approaches to opening and closing a pressure vessel). Jonsson's vessel is pressurized after it is placed in a frame adapted to absorb substantially vertical forces. The lid or top cover is moveable substantially vertically in relation to the pressure vessel after the vessel has been introduced into the frame. Other known isostatic presses fall generally into two categories.

The first category involves small diameter pressure vessels having lids which can be screwed into the pressure vessel. The other category is applicable to larger pressure vessels where the lids must be held in place or supported by another structure such as a rectilinear yoke or frame which can resist substantial tensile forces without significant deformation, for the additional support which is required. Such frames can weigh hundred of tons.

Use of such a frame requires that the pressure vessel be removed or at least pivoted from the frame each time a new workpiece is to be introduced to the vessel. Thus efficiency in loading and unloading the pressure vessel is lowered because of the need to remove the pressure vessel from the frame. All of these inefficiencies are magnified for very large presses, such as presses large enough to create a wind turbine propeller blade in a single press.

Improved Bladder Gasket with Embedded Ring

In a conventional hydraulic press there is a steel piston chamber that contains oil and as oil is pumped into the piston chamber, the piston is pushed out of the piston chamber into pressurized contact with a work piece. In an alternate, or hydro-forming press, high-pressure water is forced into a closed chamber against a metal sheet or tube and, as the pressure builds in the chamber, the sheet is pressed and stretched into a cavity behind it. Another press positions a work piece between a conventional movable forming die and an expandable bladder optionally filled with fluid under pressure. Still another press uses an enclosed inflatable container in communication with hydraulic fluid reservoirs to provide the pressure for the ram in the hydraulic press so the hydraulic fluid is never in direct contact with any of the structural mechanisms of the press.

In conventional press designs, the chamber is closed with some kind of rubber gasket or a low pressure seal, or as is the case with a hot isostatic press (HIP) a simple screw type plug lock. In a press application previously disclosed by me (see U.S. Pat. Nos. 7,862,323 and 7,910,039 which are incorporated herein by reference), the chamber is generally closed with some kind of elastomeric rubber or silicone bladder gasket, which serves both to seal the chamber and to transfer pressure from the disclosed pressure transfer medium to the work piece and mold.

Conventional high strength, low weight structural composites are made from materials such as fiberglass or graphite. The composite article is typically made of multiple layers of so-called pre-pregs (combination resin and fiber materials) which have been laid up over a mold or die and thereafter cured under selected temperature and pressure conditions. In my '323 and '029 patents, curing of the pre-preg layup is accomplished in a special kind of HIP we call a boroclave and requires the use of a barrier or bladder to separate the pressure transfer medium itself from the layers of the composite article which is being fabricated.

As the transfer medium is pressurized, pressure expands throughout the medium to provide a substantially uniform pressure against the bladder gasket to the work piece against the mold. In some applications, elastomeric stretching of the bladder gasket inside the press under working pressures can be extreme, and in some cases, great enough to tear the bladder or even pull the gasket right out of its sealing space, which in turn causes failure of the press.

What is needed is a bladder gasket that can withstand repeated extreme stretching under working pressures and which is designed so that it cannot be torn out of its sealing space.

### DISCLOSURE

### Deep Draw Active Stretch Forming of Composite Parts

The disclosed process is unique from conventional deep draw methods for ballistic composite materials. New processes for deep drawing composite materials are disclosed that leave drawn sheets of material, for instance ballistic material, with no cuts, thus transforming flat sheet composite material into three-dimensional shapes such as helmets, face masks, or any other desired shape.

In conjunction with otherwise conventional match die press apparatus and processes for otherwise conventionally drawing composite sheet materials into a female mold shape, the following is disclosed.

Ballistic materials are stacked, such as in example below, and then preheated as further described below, and then preformed inside the desired female/male mold pairing into a non-consolidated material mass. It is believed that, in the absence of significant pressure inside the mold, the material stack is subjected to only minimal pressures, and therefore there is little to no material distortion, such as stretching and/or tearing. Then as a step separate in point of time, the preformed ballistic material is placed again into the desired female/male mold and subjected to isostatic pressure and heat as further described below to consolidate the material into a post form ballistic product.

The disclosure further relates to high pressure forming of composite parts; more particularly, it relates to method and apparatus for enhancing ballistic properties of composite parts by active stretching of materials during a deep draw high pressure process; it also more particularly relates to active vacuum stabilization of materials during heating and pressing.

Surprisingly, when ballistic cloth is further actively stretched, under vacuum and heat, far greater ballistic strength is achieved in the finished composite article. Active stretch means the cloth is further stretched even while it is already hot and being pressed under ballistic forming pressures in a Boroclave or other HIP.

It has also been discovered that even a 14+ psi vacuum is enough pressure to maintain the stability of the fibers (otherwise lost as described above when such fibers are heated without any pressure stabilization), and that placing the workpiece assembly inside a vacuum bag and drawing a conventional vacuum on the bag and the workpiece before heating them adequately maintains the strength of the ballistic fibers and stabilizes them for further strength development through active stretching.

A composite part layup or stack of ballistic cloth material of selected composition and number of layers is disposed inside a conventional high temperature vacuum bag and sealed in with a vacuum valve, preferably of the quick release type, and an active vacuum is drawn down on the bag and maintained with releasable connection to the vacuum pump or other vacuum source. The bag and the composite materials inside the bag are heated in an oven or heating device under continuing active vacuum.

Once the part is at the desired temperature, the vacuum bag and its contents are removed from the oven and placed in a deep draw pressure vessel, still under active vacuum. To facilitate maintenance of the active vacuum throughout the process, part of the bag containing the vacuum valve at least, is allowed to hang out of the heating oven, and later the pressure vessel, so that active vacuum is maintained on the composite during the entire operation. The pressure vessel is then closed and the normal deep draw cycle is performed to create an active stretch within the ballistic fibers while the active vacuum is maintained on the composite until the cycle is effectively completed.

As this method enables the composite material to be heated outside of the press there can be a large number of parts preheated in advance and prepared for rapidly cycling through the press. Preferred deep draw presses are also HIP or Boroclave presses, though it is believed that unheated presses, since the material is already preheated, may also be employed to some effect.

It is also believed that pulling air and volatile gasses out of an advanced composite stack of materials produces superior composites, so the active vacuum also allows for advanced composites to be formed rapidly in a hydrostatic deep draw device or hydro forming machine, hydroclave, Boroclave or deep draw Boroclave, while also developing the maximum possible ballistic properties in the finished composite. This method advantageously employs a machine from which part of the vacuum bag may protrude or remain outside the machine during and after the vessel is locked and fully pressurized.

The disclosed vacuum preheat process may advantageously be employed regardless of whether the press is a deep draw press or not. A Boroclave or conventional HIP may be employed to press composite layups with suitable fixed (as opposed to deep draw) mold pieces, and still obtain all the disclosed advantages of active vacuum bagging and preheating.

Particular and further active stretch advantages are achieved however with a deep draw process. The heated cloth and its fibers are further stretched (beyond the conventional 30% stretch achieved in the weaving process as explained above) as they are further drawn into the deep draw configuration. It is believed that such active stretching increases ballistic properties by as much as an additional 50% to 100% over similar material that is pressed but not actively stretched while pressing.

Preform Vacuum Forming of Composite Parts with Deep Draw Active Stretch

The disclosure relates to high pressure forming of composite parts; more particularly, it relates to method and apparatus for preform active vacuum forming of materials during heating and pressing and to enhancing ballistic properties of composite parts by active stretching of materials during a deep draw high pressure process.

Surprisingly, when such ballistic cloth is further actively stretched, under vacuum and heat, far greater ballistic strength is achieved in the finished composite article. Active stretch means the cloth is further stretched even while it is already hot and being pressed under ballistic forming pressures in a Boroclave or other HIP, particularly a deep draw variation of one of these presses.

It has also been discovered that even a 14+ psi vacuum is enough pressure to maintain the stability of the fibers (otherwise lost as described above when such fibers are heated without any pressure stabilization), and that placing the workpiece assembly inside a vacuum bag and drawing a conventional vacuum on the bag and the workpiece before heating them adequately maintains the strength of the ballistic fibers and stabilizes them for further strength development through active stretching.

A composite part layup or stack of ballistic cloth material of selected composition and number of layers is disposed inside a conventional high temperature vacuum bag and sealed in with a vacuum valve, preferably of the quick release type, and an active vacuum is drawn down on the bag and maintained with releasable connection to the vacuum pump or other vacuum source. The bag and the composite materials inside the bag are heated in an oven or heating device under continuing active vacuum.

Once the part is at the desired temperature, the vacuum bag and its contents are removed from the oven and placed in a novel variation of deep draw pressure vessel, still under active vacuum. The novel variation in the press is a gap or other like structure in the enclosure or lid that allows part of the bag containing the vacuum valve at least, to hang out of the press, so that active vacuum is maintained on the composite during the entire operation. The pressure vessel is then closed, except for the part of the bag remaining outside, and the normal deep draw cycle is performed to create an active stretch within the ballistic fibers while the active vacuum is maintained on the composite until the cycle is effectively completed. A novel variation in this process is to employ a two stage pressurization of the deep draw press. The first stage is to temporarily seal the vacuum bag. The second stage is full pressure in the isostatic pressure chamber and then activation of the deep draw ram. The ram forms the part shape and does so with attendant active stretching in the workpiece.

In some processes a novel ring seal having a dished cross section is laid, dished side up, over the layed up workpiece stack of materials to help contain the material of the isostatic pressure chamber bladder, typically urethane or silicon, which is potentially deformable and squeezable right out through the novel gap. The press is closed, optionally heated, or already heated, and pressurized in two stages. During the first stage, while there is still a gap in the press enclosure opening, the dished ring seal is activated and contains the bladder material to keep it from being pushed out the gap in the press.

The disclosed vacuum preheat process may advantageously be employed regardless of whether the press is a deep draw press or not. A Boroclave or conventional HIP may be employed to press composite layups with suitable fixed (as opposed to deep draw) mold pieces, and still obtain all the disclosed advantages of active vacuum bagging and preheating.

Particular and further active stretch advantages are achieved however with a deep draw process. The heated cloth and its fibers are further stretched (beyond the conventional 30% stretch achieved in the weaving process as explained above) as they are further drawn into the deep draw configuration. It is believed that such active stretching increases ballistic properties by as much as an additional 50% to 100% over similar material that is pressed but not actively stretched while pressing.

### Dual Form Deep Draw Press Bladder

The disclosure relates to high pressure forming of composite parts in a deep draw press; more particularly, it relates to method and apparatus for a dual form bladder part in a deep draw press.

A composite part layup or stack of ballistic cloth material of selected composition and number of layers is disposed inside a conventional high temperature vacuum bag and sealed in with a vacuum valve, preferably of the quick release type, and an active vacuum is drawn down on the bag and maintained with releasable connection to the vacuum pump or other vacuum source. The bag and the composite materials inside the hag are heated in an oven or heating device under continuing active vacuum.

Once the part is at the desired temperature, the vacuum bag and its contents are removed from the oven and placed in a heated or heatable deep draw pressure vessel, still under active vacuum. To facilitate maintenance of the active vacuum throughout the process, part of the bag containing the vacuum valve at least, is allowed to hang out of the heating oven, and later the pressure vessel, so that active vacuum is maintained on the composite during the entire operation. The pressure vessel is then closed and the normal deep draw cycle is performed under heat to create an active stretch within the ballistic fibers while the active vacuum is maintained on the composite until the cycle is effectively completed.

In this deep draw press, where a workpiece is positioned and held between the movable deep draw forming die and some kind of isostatic pressure vessel generally filled with fluid under pressure, the vessel is sealed with a flexible and expandable bladder or plug, and this bladder is in working contact with the workpiece. As such it is subject to considerable wearing and tearing forces over the course of many press cycles. Conventionally, the bladder is made of a urethane compound because urethane is known for superior wear properties.

In the novel heated deep draw Boroclave or HIP press configuration disclosed however, the bladder is also subject to severe heat strains. What has not yet been developed, but is here disclosed, is a dual form bladder that is made of both urethane and silicon compounds. Desirably there are two layers to the bladder or plug, a workpiece facing layer made of urethane, and an inner layer that is exposed to the heated fluid of the pressure chamber and that is made of silicon. The two layers may be co-molded, but separate or separable, and installed together to seal the pressure fluid chamber so they act as a single bladder or plug. Alternatively, the two layers may be bonded together, either as part of the molding process in which they are formed, or after they are separately molded and formed, and before they are installed as a plug unit to seal the pressure fluid chamber.

### Containment of a Pressure Vessel

The disclosure is directed towards an improved pressure vessel construction in the field of isostatic presses; more particularly, it relates to method and apparatus for pressure vessel containment. The advances disclosed represent a departure from conventional wisdom so far about how to hold HIP presses, including Boroclaves, closed.

A very large Boroclave HIP is disclosed. Such a press can hold the composite laminate materials needed to create a very large composite structure all in one piece, for example a propellor blade for a large wind turbine (for example, with blade lengths of around 42 meters or about 140 feet). The press can readily and rapidly be opened to receive all these materials, and when closed, apply the necessary very high pressures to cause these materials to bond and transform into the kind of composite structures required.

As mentioned in the background, such a press must either be complex, or made of thick heavy steel, and/or surrounded by an enclosing frame. Alternatively, and novelly, it can be made relatively simply, and formed essentially of two semi-cylindrical hinged halves which, when closed, make a very long cylindrical bodied press. In a particular aspect of this press, when the two press halves are closed, and appropriately sealed, the two halves are held together by corresponding cylindrical steel bands that are slid into place over the ends of the now closed press halves.

The inner dimension of the bands is closely sized to be a close slip fit over the outer dimension of the closed press. It is believed that using a cylindrical construction allows stresses from inside the press to be evenly distributed over the entire circumference of the enclosing steel bands, such that, assuming there are no metallurgical anomalies, every bit of the bands receive the same strain. Thus, for a given internal press pressure, a dramatically much smaller metal mass is needed to hold the press halves closed, than if, say, a conventional steel framework were used.

The disclosed design stands in contrast to another proposed press closure system This other system uses a more conventional press with a lid, where the lid closes and then semi-cylindrical hinged bands close around the press, much like a hand grasps a coffee cup or drinking glass. The press body and lid are provided with lands, and the closure band halves are provided with corresponding interior ridges that seat upon the lands as the halves close around the press. Then, when everything is closed, the press lid is held to the press body by the metallurgic strength and shape of the closure halves. This design however does not appear to have the advantage of evenly distributing the stress from the press, which in any case does not evenly give out the pressure from inside it.

Improved Bladder Gasket with Embedded Ring

The disclosure relates to high pressure press gaskets; more particularly, it relates to method and apparatus for a press bladder gasket with an embedded metal ring.

The disclosed subject matter addresses and provides such a bladder gasket system. In the '323 and '029 patents boroclave, as the elastomeric pressure vessel (sometimes referred to as inner bladder) expands, the silicone is quickly pushed into any and all available free spaces, and then as the pressure from the expanding suspended vessel increases, the silicone is evenly distributed throughout the pressure chamber, which is generally bounded on one end by the some times called rubber piston within the pressure chamber, and the pressure from the expanding bladder is transferred through the silicone heads to the rubber piston surfaces (or to the chamber walls and the retaining barrier surfaces) uniformly. Improvements to this bladder gasket, referred to as a rubber piston in the '323 and '029 patents, are the subject of this disclosure.

A boroclave is a new kind of press or pressure chamber where both heat and isostatic pressure can be applied to layered composites over comparatively complex shapes. The Boroclave does not use water as a pressuring or pressure transfer medium. A Boroclave can be either oil or silicon filled, or a combination of both, with suitable separation materials between oil and silicone, as previously disclosed.

### BEST MODE

### Deep Draw Active Stretch Forming of Composite Parts

### Examples

In an example process, the material is drawn into an offset pre-form mold where little or no pressure is applied. It is possible for the material to stretch as it is drawn but it is at no time placed under sufficient pressure to fully consolidate it. This non consolidated part is than removed and placed in a hydrostatic pressure forming vessel and heated to the appropriate temperature to ensure resin wet out. High pressure is than applied to the part while under vacuum or positive vacuum where gasses can still flow out of the high pressure environment to the lower pressure existing outside the pressure vessel. The composite is than fully consolidated in the high pressure isostatic environment into a part with full ballistic capabilities.

This method protects the delicate fiber from any damage that would normally occur during match die operations as well as providing perfect consolidation on every surface of the complex shaped part. This is believed to be impossible in a conventional match die deep draw.

Desirably, match metal molds having an intentional offset or set off are used in the disclosed pre-forming operation. Such offset molds are specially formed or tapered to accommodate shaping of the composite material without consolidating it. In a disclosed offset mold, it will not be possible to achieve any kind of consolidation pressure, as the mold parts are offset by the expected thickness of the pre-form material stack, such that the stack can be formed but not pressed. Alternatively, a non-offset mold set may be used, but not run up to full consolidation pressures.

Using a stack of 34 layers of DSM Dyneema HB 80 sheet material, preheat material to 250 degrees. Place the preheated sheets on top of the female mold. Pass the male mold through the center of the stack smoothly and evenly drawing the material down into the female mold. Hold under light pressure (well below consolidation pressures) until the stack cools. This process creates a shell that can then be further processed utilizing omnidirectional pressure from a Boroclave or other HIP press to consolidate and finish the composite.

Other materials can be drawn in the same fashion, for example HB 26, HB 80, Honeywell 3130, Honeywell 3124, or combining polyethylene sheets such as Honeywell products and Dyneema HB 26, 50, and 80 with Kevlar products to draw composites with rigid interiors and semi rigid cores.

In a further example, a selected number of layers of HDPE cloth are layed up and covered with a conventional perforated release layer and bagged in a conventional nylon vacuum bag material into which has been sealed a conventional two-part quick release vacuum valve over some felt material to assist the bag sides from adhering under vacuum. It is believed that the perforations in the release layer also let excess resin flow through.

Optimally the skilled artisan will adjust the bagging and vacuum drawing process to adjust for variables in surface area of bag, distance of vacuum valve to workpiece layers, and vacuum pull down rate, to thus achieve a uniform vacuum throughout the bag and material and without significant bag wrinkles.

The vacuum bag and workpiece are then preheated to 270-300 degrees F. (as this is believed to be an optimum preheat stretch temp for HDPE, even though press temperature is only expected to be about 220 degrees F.).

The bagged, preheated workpiece still under vacuum is inserted into the HIP or Boroclave, with part of the vacuum bag and its valve hanging outside of the press seal, the bag still under active vacuum. The already hot press (220 F) is closed and locked and brought quickly up to 3000 psi, maintaining vacuum all through the pressing step to degas any off gassing from the material as it is pressurized under continued heat.

Press for 5 minutes at heat, then release pressure and cool slowly for about 10 minutes down to about 150 F, then rapid cool to about 80 F. Open the press and release and remove the finished article in its bag, and when cool, release vacuum and remove article from bag.

Preform Vacuum Forming of Composite Parts with Deep Draw Active Stretch

A novel preform process is also disclosed. A stack of composite material is preformed in vacuum around a complex shape, in advance of any pressing to be optionally employed. For example a stack of about 80 sheets of material are first preheated to about 250 degrees F. in an oven. A test thermocouple is advantageously used to confirm core temperature of the stack. The preheated mass of sheets is removed from the oven and laid over a preheated mold piece and sheets and mold piece are placed inside a vacuum bag. After bagging, and rigging a conventional foam tape seal around the thermocouple wire as part of the bag seal, the sheets are preformed around the mold piece as the vacuum is drawn down, and the bagged workpiece is then further heated to about 256 degrees F. and held for about 30 minutes. The part may also optionally be pressed in a Boroclave or other HIP.

### Containment of a Pressure Vessel

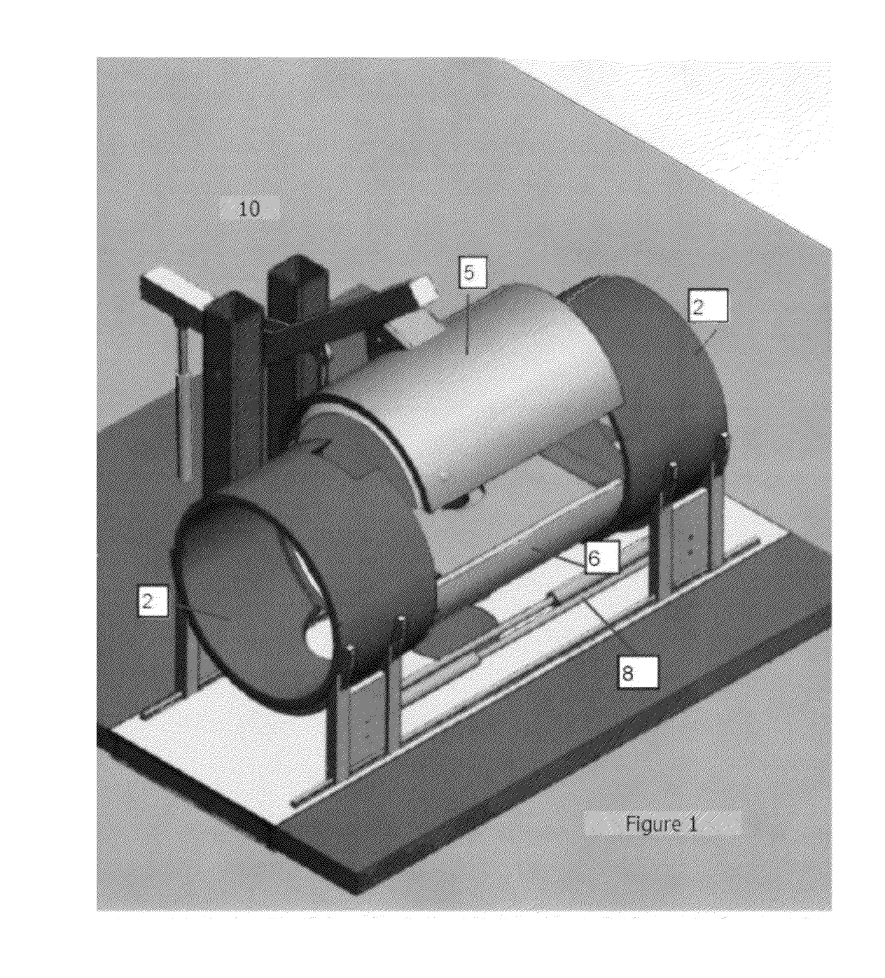

FIG. 1 is a schematic perspective view of a Boroclave press 10 having upper and lower hinged closing halves 5 and 6, and sliding closure bands 2. Suitable sliding mechanism 8 is also schematically illustrated.

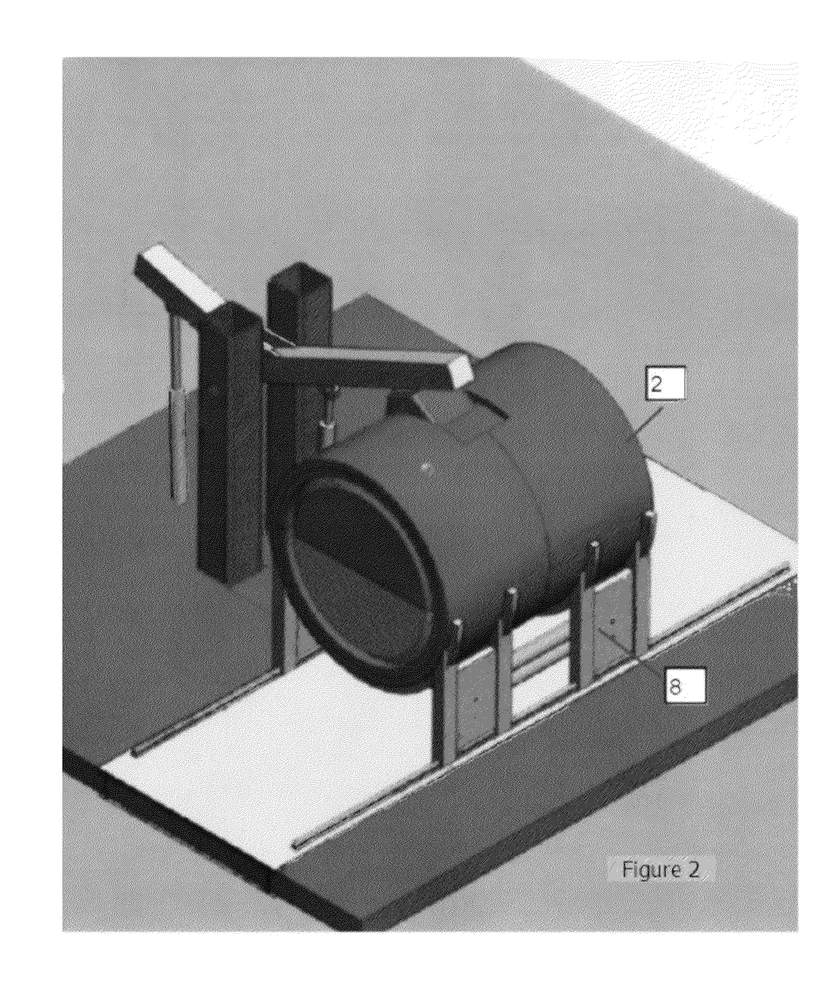

FIG. 2 is a schematic perspective view of Boroclave press 10 with hinged closing halves 5 and 6 closed, and sliding closure bands 2 drawn together to cover the press halves 5 and 6. Sliding mechanism 8 is also shown contracted to close bands 2.

Improved Bladder Gasket with Embedded Ring

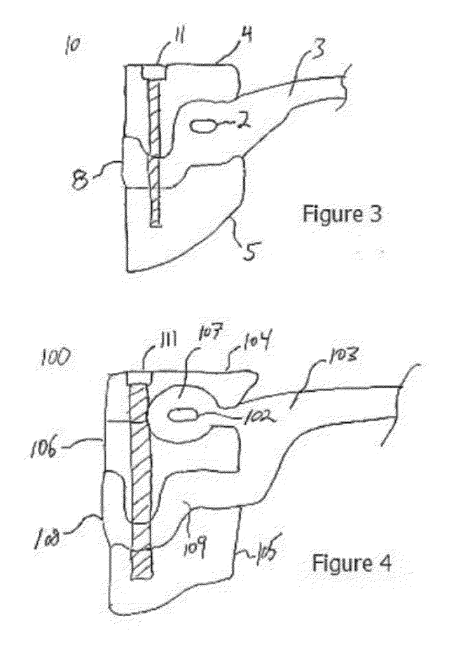

FIG. 3 is a schematic cross sectional elevation of a gasket edge design showing press closure sealing surfaces.

FIG. 4 is a schematic cross sectional elevation of an alternate gasket edge design showing press closure sealing surfaces.

Two such improved rubber bladder gaskets are disclosed. Also disclosed are press half mating surface designs in boroclave sealing areas that correspond respectively with, and are designed to retain, each respective disclosed bladder gasket. See FIGS. 3 and 4.

In a first bladder gasket design 10, its outer edge 3 is molded and shaped to fit into a correspondingly shaped metal sealing space between two press half mating surfaces 4 and 5 (held together with bolt 11), and there is a preferably metal ring 2 pre-cast into an inner part of outer edge of the bladder gasket 3, inward of outer lip or edge 8, for extra durability of the gasket edge in the clamped metal sealing space of the boroclave.

A second such bladder gasket design 100, has two distinct outer lips or edges, both of which are shaped to fit into corresponding shaped metal sealing spaces between press closure mating parts 104 and 106, and between press closure mating parts 106 and 105 (all held together with bolt 111). There is a preferably metal ring 102 pre-cast into a first lip or edge 107 of bladder gasket 103 for even more durability of the gasket edge in the clamped metal sealing space between sealing parts 104 and 106.

In both of these bladder gasket designs 10 and 100, as the bladder is stretched under working pressures to conform to the shape of the work piece on the mold, the material of the bladder is necessarily and correspondingly thinned as it stretches. For reasons that would not appear to need elaboration for those skilled in the art, the most critical area of such thinning of the bladder material is just inward of the metal clamping or sealing areas of the press. Critical thinning at these points can result in failure of the bladder gasket and corresponding failure of the press.

The gasket design 10 is believed to be an improvement over conventional sealing gasket designs, in that thinning of the gasket material at the sealing areas does not necessarily result in a pulling of gasket 3 from the sealing edges, as embedded ring 2 tends to hold the gasket material within the sealing spaces, even when it is critically thinned. A second, more distal, gasket material mass at lip 8 is also held within the sealing area and is believed to be subject to little or no thinning, as embedded ring 2 takes the residual tension of the stretch of the gasket material under pressure, without transmitting the stretching any further to the outer lip 8 of the gasket material. If stretching and damage to the gasket material is extreme however, the it is believed the most likely mode of failure is a silicone leak along the thinned gasket material in the sealing area, past the ring area, and out to the outer edge of the gasket.

The second gasket design 100 (FIG. 4) addresses such extreme conditions advantageously. Gasket lip 107 with embedded ring 2 is separate from and relatively independent from second gasket mass 109 with lip or edge 108, that goes all the way to the outside of the sealing area. Thus any stretching and thinning forces are first and preferentially applied to lip 107 reinforced with the ring, in manner like as described above for the first gasket design. That is, the material around the ring may thin, but it does not pull out, since it is held in place by the ring. Meanwhile, the other lip 109 of gasket 103 receives relatively far less of the stretching and thinning forces and therefore is subject to little if any thinning. And if partial gasket failure occurs at extreme conditions, the failure occurs at the lip with the ring, and silicone penetrates the gasket, but does not escape the press. This is especially aided in embodiments where the outermost mating sealing surfaces advantageously define a tortuous path (see space between parts 105 and 106) for the second lip or edge 109 of gasket 103.

In compliance with the statute, the invention has been described in language more or less specific as to structural features. It is to be understood, however; that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A press having upper and lower hinged closing halves, and one or more sliding closure bands each operatively actuated by a sliding mechanism.
